(19) United States
(12) Patent Application Publication
(10) Pub. No.: US 2008/0284787 A1
(43) Pub. Date: Nov. 20, 2008

(54) Information processing system, method for controlling system and computer-readable recording medium

(75) Inventor: Hiroyuki Komai, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMTED, Kawasaki (JP)

(21) Appl. No.: 12/010,086

(22) Filed: Jan. 18, 2008

(30) Foreign Application Priority Data
Jan. 19, 2007 (JP) 2007-010792

(51) Int. Cl. G09G 5/36

(52) U.S. Cl. 345/547

(57) ABSTRACT

According to an aspect of an embodiment, a system comprises a processing unit for executing a software program, a storage unit and a display unit for displaying information for the software program, the processing unit saving the instant displayed information and associated data relating to the software program into the storage unit when instructed, the processing unit maintaining the information to be displayed and superimposing supplementary information over the information on the display unit while the information and associated data are being saved.

### BACKGROUND OF THE INVENTION

1. Field of the Invention

The present invention relates to overlay display of image data.

2. Description of the Related Art

A technology described in Japanese Unexamined Patent Application Publication No. 06-19807 is available as an example of the related art.

### SUMMARY

According to an aspect of an embodiment, a system comprises a processing unit for executing a software program, a storage unit and a display unit for displaying information for the software program, the processing unit saving the instant displayed information and associated data relating to the software program into the storage unit when instructed, the processing unit maintaining the information to be displayed and superimposing supplementary information over the information on the display unit while the information and associated data are being saved.

### BRIEF DESCRIPTION OF THE DRAWINGS

FIG. 1 is a schematic view of an information processing apparatus and a display device;

FIG. 2 shows the entire hardware configuration of the information processing apparatus and the display device;

FIG. 3 is a functional block diagram of overlay display processing;

FIG. 4 is a flowchart of a process for overlay display processing performed by the information processing apparatus;

FIG. 5 is a flowchart of a process for overlay display processing performed by the display device;

FIG. 6 shows a state (part 1) in which data storage processing is being performed;

FIG. 7 is a functional block diagram of data storage processing;

FIG. 8 is a flowchart of a process for data storage processing performed by the information processing apparatus;

FIG. 9 is a flowchart of a start-up process;

FIG. 10 shows a state after IMM is started up;

FIG. 11 shows a state (part 2) in which data storage processing is being performed;

FIGS. 12A to 12F show an example in which an embodiment is carried out; and

FIG. 13 is an illustration for explaining IMM.

### DESCRIPTION OF THE PREFERRED EMBODIMENTS

Preferred embodiments will be described with reference to the drawings.

An information processing apparatus generally adopts a method described below in order to display image data on a display device. The processing apparatus acquires data to be displayed as image data from among data loaded in a main memory. Then, the processing apparatus writes the image data into a video memory. The data written into the video memory is transmitted to the display device, and the display device displays the image data. Accordingly, image data to be displayed on the display device passes through the video memory.

When overlay display in which image data is superimposed on displayed image data is performed, for example, in order to provide a warning to a user, the processing apparatus also writes the image data to be superimposed on the displayed image data into the video memory.

However, according to the above-mentioned method, for image data to be superimposed on displayed image data, the processing apparatus must also acquire, from among data loaded in the main memory, an image file forming the image data to be displayed and information on the position in which the image file is to be displayed and then write the acquired image file and information into the video memory. That is, all the image data to be displayed on the display device must pass through the video memory.

### First Embodiment

### Schematic View of Information Processing Apparatus and Display Device:

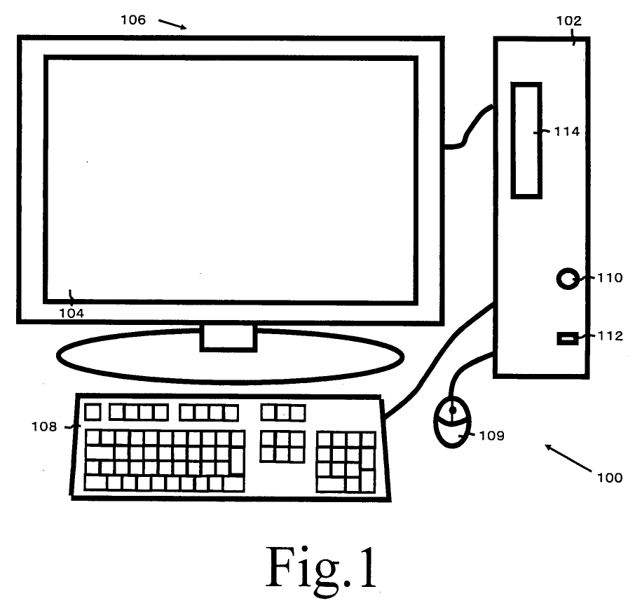

FIG. 1 is a schematic view of an information processing apparatus and a display device. An information processing apparatus 100 includes an information processing apparatus main body 102, a keyboard 108, and a mouse 109. The information processing apparatus main body 102 contains a central processing unit (CPU), a memory, and the like. Each of the keyboard 108 and the mouse 109 is used for issuing a command to the information processing apparatus 100. The information processing apparatus main body 102 includes the keyboard 108, which is used for issuing a command to the information processing apparatus 100 by a user operation, the mouse 109, which is used for moving a cursor on a liquid crystal display (LCD) panel 104 and issuing a command corresponding to an icon or the like on which the cursor is positioned, a power button 110 used for turning on the power of the information processing apparatus 100, a universal serial bus (USB) connector 112 conforming to a USB standard, and a compact disc/digital versatile disc (CD/DVD) loading slot 114 into which a CD or a DVD is loaded. A display device 106 displays an image in response to a command received from the information processing apparatus main body 102.

### Hardware Configuration:

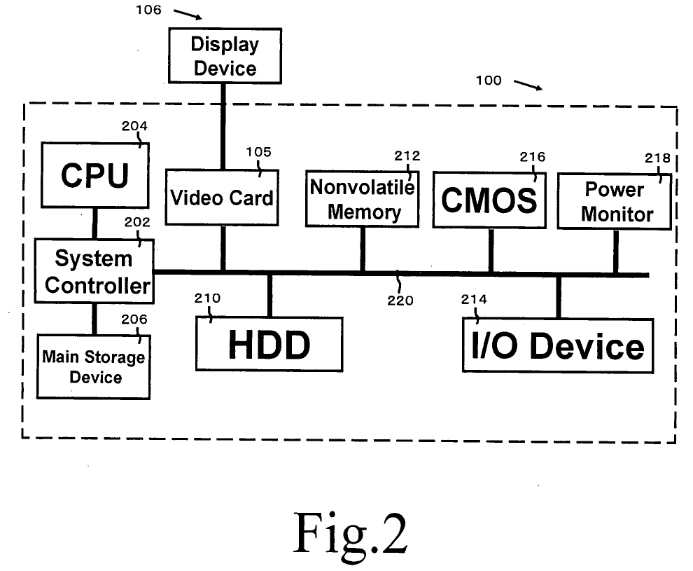

FIG. 2 is a block diagram briefly showing an example of the hardware configuration of the information processing apparatus 100 and the display device 106 shown in FIG. 1. The same blocks as described with reference to FIG. 1 are denoted by the same reference numerals. The information processing apparatus 100 includes a system controller 202, a CPU 204, a main storage device 206, a video card 105, a hard disk drive (HDD) 210, a nonvolatile memory 212, an input/output (I/O) device 214, a complementary metal-oxide semiconductor (CMOS) 216, a power monitor 218, and a bus 220. Each of the blocks is connected to the system controller 202 via the bus 220. The display device 106 is connected to the video card 105. Each of the blocks will be described below.

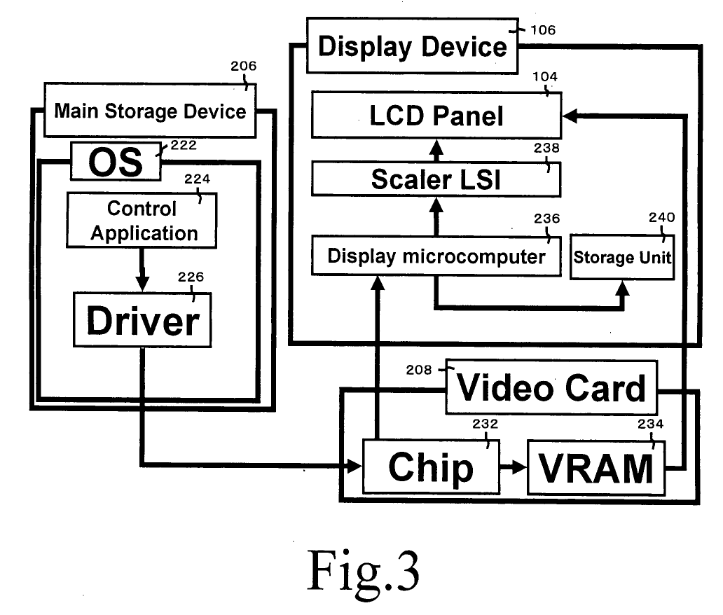

The system controller 202 performs control of the entire system, such as control of data input and output. The CPU 204 executes various software programs, such as an operating system (OS), loaded in the main storage device 206. The main storage device 206 is used as an operation area for the execution of a program read from the HDD 210. In this embodiment, an OS, an application, a driver, and the like are loaded in the main storage device 206. The main storage device 206 will be described in detail later with reference to FIG. 3. The display device 106 displays an image in response to a command issued from the CPU 204 through the video card 105. And The display device 106 displays information for the software program. The display device 106 will be described in detail later with reference to FIG. 3. The HDD 210 stores an OS and an application program. Such programs are read by the system controller 202 and loaded into the main storage device 206. The nonvolatile memory 212 stores a basic input/output system (BIOS) program that is executed immediately after the power of the information processing apparatus 100 is turned on. The I/O device 214 transmits to the system controller 202 an input received from the keyboard 108, the mouse 109, or the like. The CMOS 216 stores settings of a BIOS menu. The power monitor 218 monitors whether the power button 110 is operated.

### Functional Block Diagram of Overlay Display Processing

FIG. 3 is a functional block diagram briefly showing an example of overlay display processing. An overlay display function is implemented by the main storage device 206, a video card 208, and the display device 106. Each of the blocks will be described below.

An OS 222 is loaded into the main storage device 206. In the OS 222, a control application 224 and a driver 226 are loaded. The control application 224 transmits via the driver 226 to the display device 106 a signal for performing overlay display of image data stored in the display device 106.

The display device 106 includes a display microcomputer 236, a scaler large-scale integrated circuit (LSI) 238, and an LCD panel 104. The display device 106 is connected to the video card 208 contained in the information processing apparatus 100. The video card 208 includes a chip 232 and a video random access memory (VRAM) 234. The display microcomputer 236 provides a function of adjusting the brightness, chromaticity, contrast, and the like of a screen on the LCD panel 104. The scaler LSI 238 performs conversion of the format and resolution of video. The video card 208 includes the chip 232, which draws an image, and the VRAM 234, which holds a screen image. The chip 232 receives image data from the CPU 204 and writes the image data into the VRAM 234 holding a screen image. Image data that is to be displayed on the display device 106 among data loaded in the main storage device 206 is written into the VRAM 234. The CPU 204 transmits to the display device 106 the image data written into the VRAM 234, and the display device 106 displays the image data. The chip 232 transmits to the display microcomputer 236 a signal, which is transmitted from the control application 224 via the driver 226, for performing overlay display of image data. Image data to be overlay-displayed on displayed image data is stored in a storage unit 240. When receiving from the chip 232 a signal for performing overlay display, the display microcomputer 236 selects and acquires image data to be displayed from the storage unit 240 and displays the acquired image data.

### Flow of Process Performed by Information Processing Apparatus:

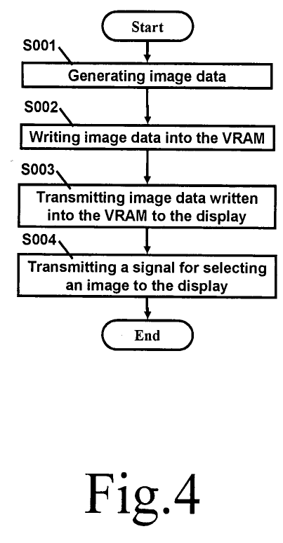

A process in which the CPU 204 causes the display device 106 to display image data among data loaded in the main storage device 206 and transmits to the display device 106 a signal for performing overlay display of image data will be described with reference to FIG. 4.

In step 001, the CPU 204 acquires, from among data loaded in the main storage device 206, an image file forming image data to be displayed and information on the position in which the image file is to be displayed, and generates the image data. Then, the process proceeds to step S002.

In step S002, the CPU 204 causes the chip 232 to write the generated image data into the VRAM 234. Then, the process proceeds to step S003.

In step S003, the CPU 204 transmits to the display device 106 the image data written into the VRAM 234. Then, the process proceeds to step S004.

In step S004, the CPU 204 causes the control application 224 to transmit to the display device 106 a signal for selecting an image to be overlay-displayed on displayed image data. Then, the process is terminated.

### Flow of Process Performed by Display Device:

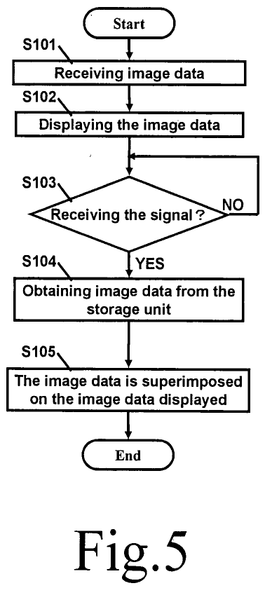

A process in which the display device 106 displays image data transmitted from the information processing apparatus 100 and displays another image data so as to be superimposed on the displayed image data will be described with reference to FIG. 5.

In step S101, the display device 106 receives image data transmitted from the information processing apparatus 100. Then, the process proceeds to step S102.

In step S102, the display device 106 displays the image data on the LCD panel 104. Then, the process proceeds to step S103.

In step S103, the display microcomputer 236 determines whether a signal for selecting image data to be overlay-displayed on the displayed image data has been transmitted from the control application 224 via the driver 226. If it is determined in step S103 that the signal has been transmitted, the process proceeds to step S104.

In step S104, the display microcomputer 236 acquires image data to be overlay-displayed on the displayed image data from the storage unit 240 in accordance with the signal. Then, the process proceeds to step S105.

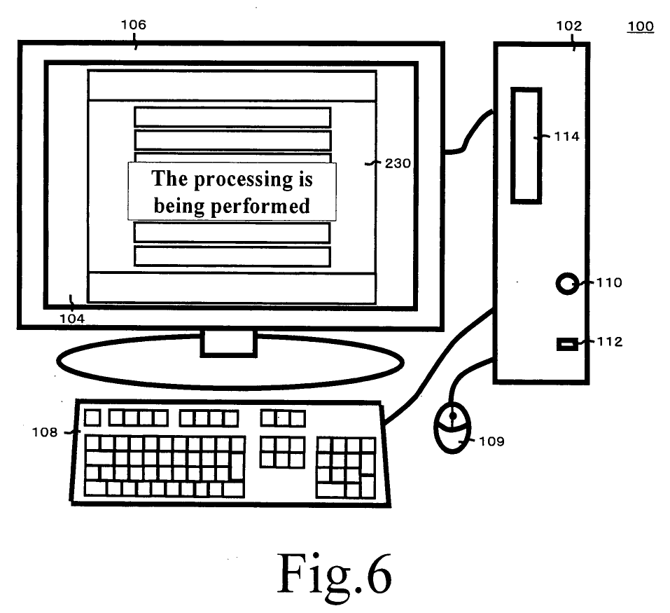

In step S105, the display microcomputer 236 displays the acquired image data on the LCD panel 104 via the scaler LSI 238 so as to be superimposed on the image data displayed in step S102. FIG. 6 shows an example in which image data is superimposed on displayed image data. For example, referring to FIG. 6, image data indicating that processing is being performed is displayed so as to be superimposed on displayed image data of an application. As described above, when receiving a signal from the information processing apparatus 100, the display device 106 overlay-displays image data stored in the display device 106 so as to be superimposed on displayed image data. Thus, overlay display of image data can be efficiently achieved.

### Second Embodiment

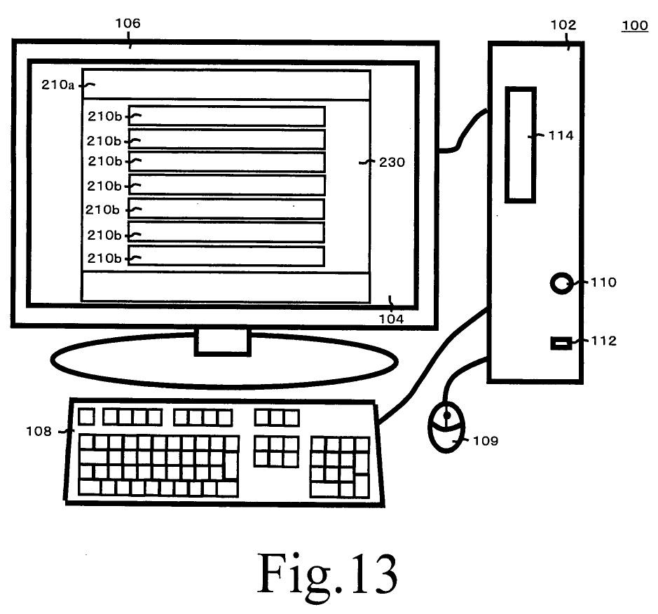

In a second embodiment, an example in which the technology relating to overlay display explained in the first embodiment is used for hibernation will be described. In the second embodiment, installation of Instant MyMedia™ (IMM) into the information processing apparatus 100 and processing to be performed for enabling IMM in the information processing apparatus 100 will be described. IMM is an application that provides a function for TV, CD, or DVD viewing and listening in the information processing apparatus 100. As shown in FIG. 13, IMM 230 mainly includes a task bar 210a and switch buttons 210b. The name of IMM indicated on the task bar 210a. “TV”, “DVD/CD”, “music” or the like is indicated on each of the switch buttons 210b. A user is able to use a DVD function or the like in the information processing apparatus 100 by operating one of the switch buttons 210b corresponding to a desired function. It takes a long time to start the execution of such an application in the information processing apparatus 100. Thus, a hibernation technology is used to reduce the time required for starting the execution and to achieve high-speed start-up. Hibernation is a technology for copying to a hard disk data stored in a memory immediately before the power is turned off and for reading the data from the hard disk at the next start-up so as to recover the state immediately before the power was turned off.

### Functional Block Diagram of Data Storage Process:

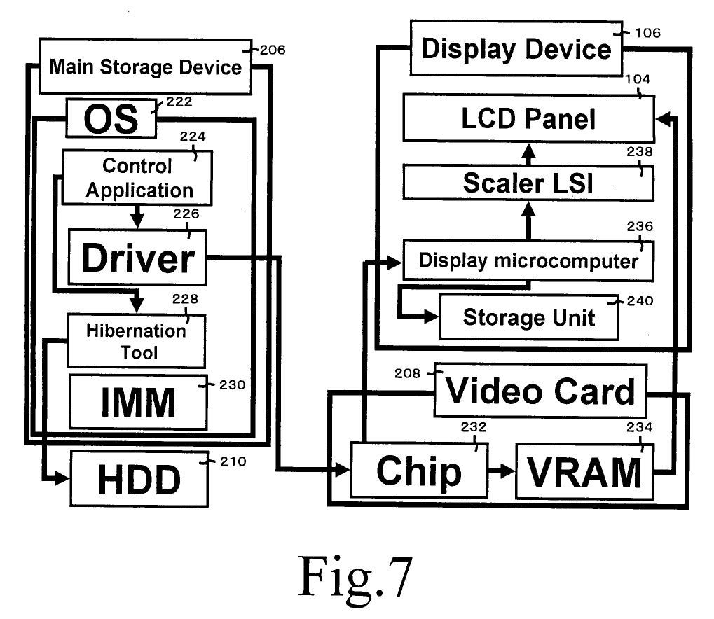

FIG. 7 is a functional block diagram briefly showing an example of processing for storing data loaded in the main storage device 206 into the HDD 210. A data storage function is implemented by the main storage device 206, the HDD 210, and the display device 106. Each of the blocks will be described below.

The OS 222 is loaded into the main storage device 206. In the OS 222, in addition to the control application 224 and the driver 226 described with reference to FIG. 3, a hibernation tool 228 and the IMM 230 are loaded. In addition to the functions described with reference to FIG. 3, the control application 224 issues a command to the hibernation tool 228 to start data storage processing and monitors the progress rate of data storage processing of the hibernation tool 228. The hibernation tool 228 receives an instruction issued from the control application 224, and saves instant displayed information and associated data relating to the software program into the HDD 210. While the information and associated data are being saved, CPU 204 maintains the information to be displayed and superimposing supplementary information over the information on the display unit 106.

### Flow of Data Storage Process:

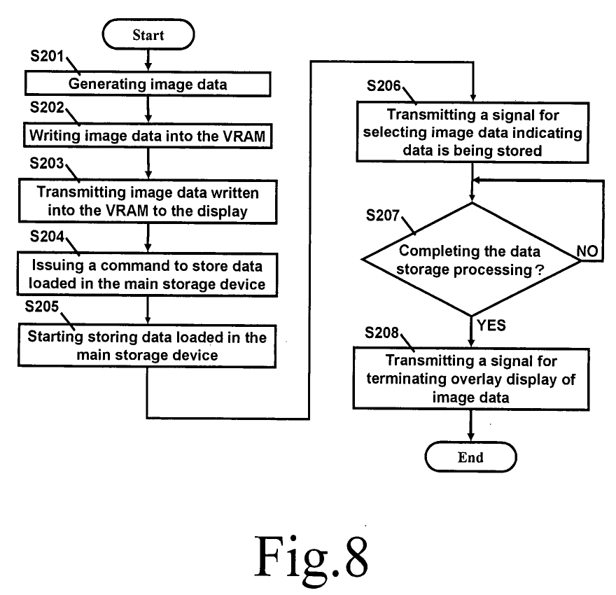

A process for storing data loaded in the main storage device 206 into the HDD 210 will be described with reference to FIG. 8.

In step S201, the CPU 204 acquires, from among data loaded in the main storage device 206, an image file forming image data to be displayed and information on the position in which the image file is to be displayed, and generates the image data. Then, the process proceeds to step S202.

In step S202, the CPU 204 causes the chip 232 to write the generated image data into the VRAM 234. Then, the process proceeds to step S203.

In step S203, the CPU 204 transmits to the display device 106 the image data written into the VRAM 234. Then, the process proceeds to step S204.

In step S204, the control application 224 issues a command to the hibernation tool 228 to store data loaded in the main storage device 206. Then, the process proceeds to step S205.

In step S205, the hibernation tool 228 starts the processing for storing the data loaded in the main storage device 206 into the HDD 210. The hibernation tool 228 collectively stores, as a single block, image data that is to be displayed on the display screen of the information processing apparatus 100 among data of the IMM 230 into the HDD 210. By collectively storing image data, as a single block, into the HDD 210, the IMM 230 can be started up next time at a high speed. This is because when the IMM 230 is started up, display of image data can be achieved by loading the image data that has been collectively stored as a single block into the main storage device 206. Then, the process proceeds to step S206.

In step S206, the control application 224 transmits to the display device 106 a signal for selecting image data including a save operation. Then, the process proceeds to step S207.

In step S207, the control application 224 determines whether the hibernation tool 228 has completed the data storage processing. If it is determined in step S207 that the hibernation tool 228 has completed the data storage processing, the process proceeds to step S208.

In step S208, the control application 224 transmits to the display device 106 a signal for terminating overlay display of image data. Then, the process is terminated.

Accordingly, when the hibernation tool 228 starts processing for storing data loaded in the main storage device 206, image data indicating that data is being stored is overlay-displayed on the LCD panel 104 of the display device 106. Thus, even when it takes a long time to store data loaded in the memory, a user does not understand that the information processing apparatus 100 is freezing up. Thus, the information processing apparatus 100 is prevented from being forcibly terminated. Image data to be overlay-displayed is not loaded into the memory before being displayed on the LCD panel 104. The display microcomputer 236 of the display device 106 selects image data from the storage unit 240, and displays the image data on the LCD panel 104. Thus, even if image data indicating that data is being stored is displayed when data is being stored into the memory, the image data is not stored in the HDD 210.

### Flow of Start-up Process:

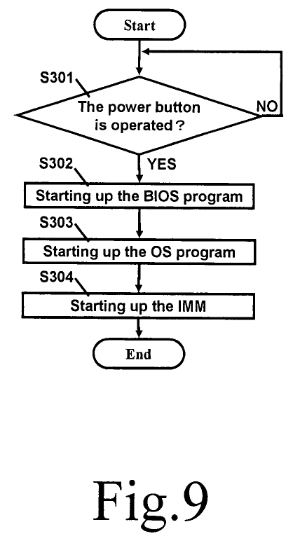

A process in which the IMM 230 is started up after hibernation processing is performed in accordance with the second embodiment will be described with reference to FIG. 9.

In step S301, the power monitor 218 determines whether the user has operated the power button 110. If it is determined in step S301 that the user has operated the power button 110, the process proceeds to step 302.

In step S302, when the user operates the power button 110, the CPU 204 starts up a BIOS program stored in the nonvolatile memory 212. When the CPU 204 starts up the BIOS program, the BIOS program initializes the system controller 202. Then, the BIOS program is loaded into the main storage device 206. Then, the process proceeds to step S303.

In step S303, when test and initialization of hardware have been completed, the BIOS program starts up the OS. Then, the process proceeds to step S304.

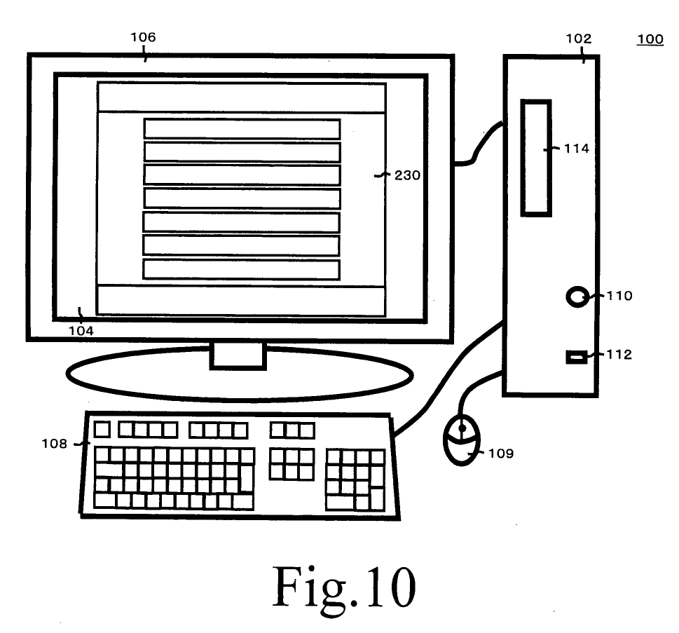

In step S304, the OS starts up the IMM 230. The start-up of the IMM 230 is achieved when the hibernation tool 228 loads data stored in the HDD 210 into the OS. FIG. 10 shows a state in which the IMM 230 is started up. Then, the process is terminated.

Accordingly, when the IMM 230 is started up, unnecessary image data is not displayed on the LCD panel 104.

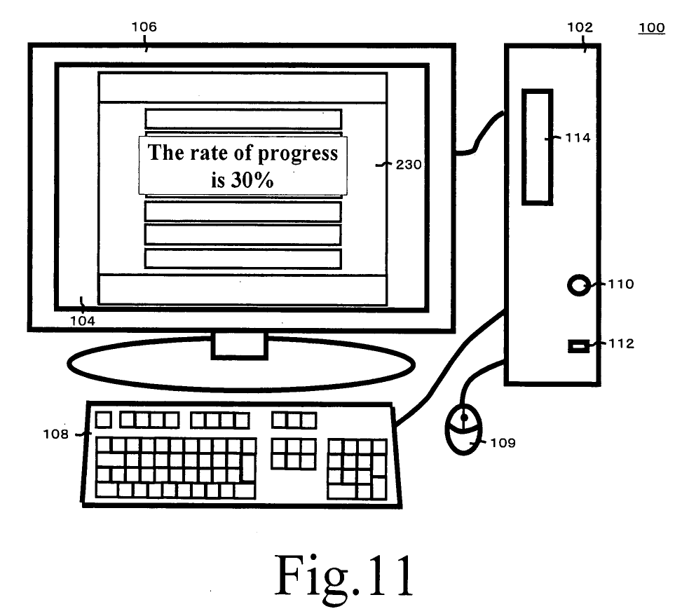

The above-described embodiments are specifically explained for clear understanding of embodiments. The preferred embodiments are not limited to any of the above-described embodiments. Various changes and modification can be made to the preferred embodiments. For example, although image data indicating that processing is being performed is overlay-displayed in FIG. 5, the progress rate of data storage processing may be overlay-displayed, as shown in FIG. 11.

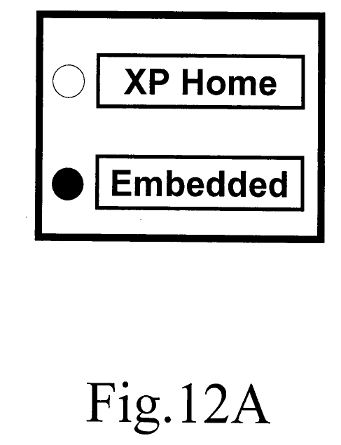

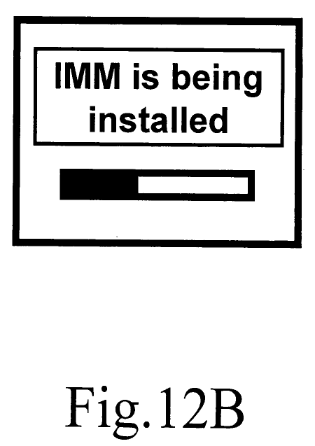

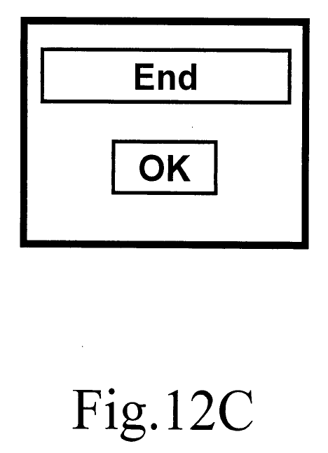

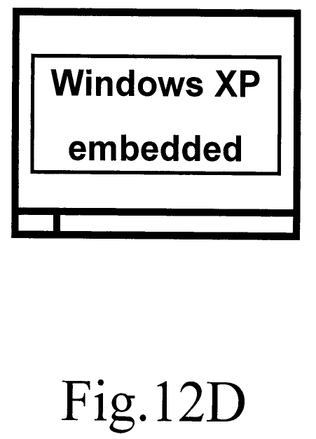

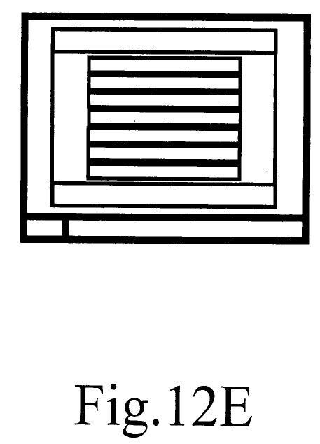

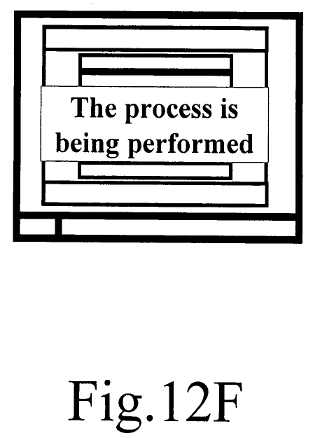

A detailed example in which an embodiment is applied to installation of IMM will be described with reference to FIGS. 12A to 12F. An OS explained here is merely an example. In order to use IMM in the information processing apparatus 100, it is necessary to install IMM into the information processing apparatus 100 using an installation CD. In this example, in order to use IMM on Windows® XP Embedded, not on Windows® XP Home, “Embedded” is selected on the installation screen (see FIG. 12A). This is because since Windows XP Embedded is started up faster than Windows XP Home, IMM using Windows XP Embedded is started up faster than IMM using Windows XP Home. Accordingly, the installation of IMM starts (see FIG. 12B). When the installation is completed, the display screen reaches the state shows in FIG. 12C. Then, processing for starting up IMM at a high speed in the information processing apparatus 100 is performed. First, Windows XP Embedded is started up (see FIG. 12D). Then, the installed IMM is started up and displayed on the screen (see FIG. 12E). The CPU 204 writes image data into the VRAM 234 and then transmits the image data to the display device 106. Then, in FIG. 12F, storing of data loaded in the memory starts, and hibernation is performed. In the execution of hibernation, the CPU 204 transmits to the display device 106 a signal for displaying image data indicating that data is being stored. In hibernation, image data that is to be displayed on the screen among IMM data loaded in the memory is collectively stored as a single block into the HDD 210. Since it takes a long time to perform the processing shown in FIG. 12F, when the display device 106 receives a signal indicating that data is being stored, the display device 106 overlay-displays image data indicating that data is being stored. As described above, image data to be overlay-displayed is displayed on the display device 106 by the display microcomputer 236 of the display device 106. Thus, even if image data indicating that data is being stored is displayed when data loaded in the memory is being stored, the image data is not stored. Thus, unnecessary image data is not displayed when IMM is started up next time.

What is claimed is:

1. A system comprising:
a processing unit for executing a software program;
a storage unit; and
a display unit for displaying information for the software program, the processing unit saving the instant displayed information and associated data relating to the software program into the storage unit when instructed, the processing unit maintaining the information to be displayed and superimposing supplementary information over the information on the display unit while the information and associated data are being saved.

2. The system of claim 1, wherein the supplementary information is stored in the display unit.

3. The system of claim 1, wherein the supplementary information is a message.

4. The system of claim 1, wherein the supplementary information is a message including a save operation.

5. The system of claim 1, wherein the supplementary information is a message including a progress of a save operation.

6. The system of claim 1, wherein the processing unit finishes superimposing supplementary information upon accomplishing saving the information and associated data.

7. A method for controlling a system, the system including a processing unit for executing a software program, a storage unit and a display unit for displaying information for the software program, the method comprising;
saving the instant displayed information and associated data relating to the software program into the storage unit when instructed;
maintaining the information to be displayed; and
superimposing supplementary information over the information on the display unit while the information and associated data are being saved.

8. The method of claim 7, wherein the supplementary information is stored in the display unit.

9. The method of claim 7, wherein the supplementary information is a message.

10. The method of claim 7, wherein the supplementary information is a message including a save operation.

11. The method of claim 7, wherein the supplementary information is a message including a progress of a save operation.

12. The method of claim 7, further comprising finishing superimposing supplementary information upon accomplishing saving the information and associated data.

13. A computer-readable recording medium that stores a computer program for controlling a system, the system including a processing unit for executing a software program, a storage unit and a display unit for displaying information for the software program, according to a process comprising;
saving the instant displayed information and associated data relating to the software program into the storage unit when instructed;
maintaining the information to be displayed; and
superimposing supplementary information over the information on the display unit while the information and associated data are being saved.

14. The computer-readable recording medium of claim 13, wherein the supplementary information is stored in the display unit.

15. The computer-readable recording medium of claim 13, wherein the supplementary information is a message.

16. The computer-readable recording medium of claim 13, wherein the supplementary information is a message including a save operation.

17. The computer-readable recording medium of claim 13, wherein the supplementary information is a message including a progress of a save operation.

18. The computer-readable recording medium of claim 13, further comprising finishing superimposing supplementary information upon accomplishing saving the information and associated data.
